(19) United States
(12) Patent Application Publication
(10) Pub. No.: US 2023/0316950 A1
(43) Pub. Date: Oct. 5, 2023

(54) SELF- ADAPTING AND AUTONOMOUS METHODS FOR ANALYSIS OF TEXTUAL AND VERBAL COMMUNICATION

(71) Applicant: GET MEE PTY LTD, PRAHRAN, VICTORIA (AU)

(72) Inventor: Balendran THAVARAJAH, PRAHRAN, VICTORIA (AU)

(21) Appl. No.: 18/006,257

(22) PCT Filed: Jul. 22, 2021
(86) PCT No.: PCT/AU2021/050792

§ 371 Date: Jan. 20, 2023

(30) Foreign Application Priority Data
Jul. 23, 2020 (AU) 2020902557

(51) Int. Cl. G09B 19/04; G10L 25/63; G10L 15/187; G10L 25/90; G06F 40/279; G10L 15/06; G06F 3/16; G10L 15/22

(52) U.S. Cl. CPC G09B 19/04; G10L 25/63; G10L 15/187; G10L 25/90; G06F 40/279; G10L 15/063; G06F 3/167; G10L 15/22; G10L 2015/225

(57) ABSTRACT

Method and device for audio and text processing by for analysing verbal or written communication of an individual. The method provides automated feedback on verbal or textual communication. The method may be implemented in respect of verbal communication by analysing an input audio signal containing speech of an individual to identify a presence, absence or quality of a speech characteristic and/or a syntax characteristic, and outputting feedback by an electronic user interface to the individual. Similar analysis and output may be provided in respect of text written by the individual. The analysis may identify a desirable or an undesirable emotion in the verbal or written communication.

### FIELD OF THE INVENTION

The present invention relates generally to the field of audio processing and text processing. More particularly, the present invention relates to the processing of speech or text for the purpose of analysing the verbal or written communication of an individual with the aim of improving communications.

### BACKGROUND TO THE INVENTION

Effective communication is a key skill in establishing and maintaining business and personal relationships. An individual may spend an inordinate amount of time wondering whether a verbal conversation or interchange of written material with another person, or a presentation given to a group was effective and not flawed in some manner.

Motivation for improvement in verbal communication skills include the desire to be more persuasive, secure better engagement with a listener, and be taken as more friendly or appealing.

An individual may seek the opinion of a colleague, relative or friend in relation to their verbal communications skills to identify areas requiring improvement. Seeking an opinion in this way is possible when the parties are sufficiently well enough known to each other, however the individual must question the impartiality of any opinion obtained. For example, a friend may be overly kind and suggest little or no improvement is needed, when in fact the individual's communication skills are in need of significant improvement. Conversely, a work colleague may seek to undermine the individual's confidence to bolster his/own prospects for career advancement and provide an unduly harsh opinion.

It is known in the prior art for a presenter to be assessed by the audience after a presentation. Typically, the audience is asked to rate the presenter across a number of categories, and possibly also provide further comments on the presenter as free text. Again, it is often the case that a less than truthful assessment may be received. A presenter may come across as very likeable, or humorous and the audience feels obligated to give a positive assessment, when in fact on an objective view the presenter's delivery was not sufficiently positive, or their speech was too rapid.

In any event, in many circumstances an assessment of verbal performance is given after the fact, and when any negative impression has already been left on a listener.

It is known in the art that audio processing software may be used to analyse speech. A technical problem is that real-time analysis places a significant burden on a processor, and particularly for relatively low powered mobile processors such as those used in smart phones, tablets and some lap-top computers. A further problem is that prior art audio processing software may not be able to identify positive and negative characteristics of human speech with sufficient accuracy to provide an individual with a useful indication of verbal communication performance.

It is further known that many individuals seek some understanding of their general state of mind. Such insights can be very useful in the self-assessment of mental health, and can be used to monitor state of mind over a period of time with the overall aim of improvement. For example, it is helpful for an individual to know when their state of mind is becoming progressively more negative over time such that a regime may be put in place to retrain the mind back toward positivity.

It is an aspect of the present invention to provide an improvement to methods for the assessment of verbal communication and/or the general state of mind of an individual. It is a further aspect of the present invention to provide a useful alternative to prior art methods.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a computer-implemented method for providing automated feedback on verbal or textual communication, the method comprising the steps of:
(i) in respect of verbal communication analysing an input audio signal comprising speech of a first human individual by one or more audio signal analysis modules so as to identify the presence, or absence or quality of a speech characteristic and/or a syntax characteristic, and
outputting feedback on the presence, or absence or quality of a speech characteristic or a syntax characteristic by an electronic user interface so as to be comprehensible to the first human individual; or
(ii) in respect of textual communication, analysing an input text written a first human individual by one or more text analysis modules so as to identify the presence, absence or quality of a text characteristic and/or a syntax characteristic, and
outputting feedback on the presence, absence or quality of a text characteristic or syntax characteristic by an electronic user interface so as to be comprehensible to the first human individual.

In one embodiment of the first aspect, the input audio signal is obtained from a microphone transducing speech of the first human individual in participating in an activity selected from the group consisting of: a cell phone voice call, an IP phone voice call, a voicemail message, an online chat, an online conference, an online videoconference, and a webinar.

In one embodiment of the first aspect, discontinuous portions of the input audio signal are analysed so as to lessen processor burden of the computer executing the method.

In one embodiment of the first aspect, the analysis of the input audio signal, or discontinuous portions of the input audio signal occurs substantially on-the-fly.

In one embodiment of the first aspect, one of the one or more audio signal or text analysis modules is an emotion analysis module configured to identify an emotion in speech or text.

In one embodiment of the first aspect, the emotion is selected from the group consisting of anger, nervousness, joy, boredom, disgust, fear, sadness, enthusiasm, interest, disinterest, despair, aggressiveness, assertiveness, distress, passiveness, dominance, submissiveness, confusion, puzzlement, inquisitiveness, tiredness, ambivalence, motivation, and attentiveness.

In one embodiment of the first aspect, one of the one or more audio signal analysis modules is a comprehensibility or pronunciation analysis module configured to identify a comprehensibility or pronunciation speech characteristic.

In one embodiment of the first aspect, one of the one or more audio signal analysis modules is a volume or frequency analysis module configured to identify a volume or a frequency (pitch) speech characteristic.

In one embodiment of the first aspect, one of the one or more audio signal analysis modules is a delivery and/or pause analysis module configured to identify a speed of delivery and/or a pause speech characteristic.

In one embodiment of the first aspect, one of the one or more audio signal analysis modules is a speech-to-text converter module configured to convert speech encoded by the audio signal into a text output.

In one embodiment of the first aspect, the text is a word or a word string.

In one embodiment of the first aspect, the one or more text analysis modules is/are configured to input text written by the first human individual, the text being in the form of a word or a word string.

In one embodiment of the first aspect, the word or word string is extracted from an electronic message of the first human individual.

In one embodiment of the first aspect, the electronic message is selected from the group consisting of an email, a cell phone SMS text message, a communications app message, a post on a social media platform, or a direct message on a social media platform.

In one embodiment of the first aspect, one of the one or more text analysis modules is configured to analyse a word or a syntax characteristic of text.

In one embodiment of the first aspect, the word or the syntax characteristic is selected from the group consisting of: word selection, word juxtaposition, word density, phrase construction, phrase length, sentence construction, and sentence length.

In one embodiment of the first aspect, one of the one or more text analysis modules is an emotion analysis module configured to identify an emotion in text.

In one embodiment of the first aspect, the emotion is selected from the group consisting of anger, nervousness, joy, boredom, disgust, fear, sadness, enthusiasm, interest, disinterest, despair, aggressiveness, assertiveness, distress, passiveness, dominance, submissiveness, confusion, puzzlement, inquisitiveness, tiredness, ambivalence, motivation, and attentiveness.

In one embodiment of the first aspect, one or more of the emotion analysis modules is/are trained to identify an emotion in an audio signal of human speech by reference to a population dataset.

In one embodiment of the first aspect, one or more of the emotion analysis modules have been trained by the use of a machine learning method so as to associate a characteristic of an audio signal with an emotion by reference to the population dataset

In one embodiment of the first aspect, the computer-implemented method comprises ongoing training of a machine learning module by ongoing analysis of audio signals of the first human individual so as to increase accuracy over time of the emotion analysis module.

In one embodiment of the first aspect, one or more of the emotion analysis modules identifies an emotion in text by reference to an electronically stored predetermined association between (i) a word or a word string and (ii) an emotion.

In one embodiment of the first aspect, the machine learning module requires expected output data, the expected output data provided by the first human individual, another human individual, a population of human individuals, or the emotion output of a text analysis module.

In one embodiment of the first aspect, the computer-implemented method comprises a profiling module configured to receive output from one or more of the one or more emotion analysis modules and generate a profile of the first human individual.

In one embodiment of the first aspect, the profile is in relation to an overall state of emotion of the first human individual.

In one embodiment of the first aspect, a profile is generated at two or more time points of an audio signal, and/or at two different points in a text (where present).

In one embodiment of the first aspect, the computer-implemented method comprises analysing an input audio signal comprising speech of a second human individual by one or more audio signal analysis modules so as to identify the presence or absence of a speech characteristic and/or a syntax characteristic, wherein the second human individual is in communication with the first human individual.

In one embodiment of the first aspect, the computer-implemented method comprises analysing text of a second human individual by one or more text analysis modules so as to identify the presence or absence of a text characteristic of the second human individual.

In one embodiment of the first aspect, the audio/signal and or text is obtained by the same or similar means as for the first human individual.

In one embodiment of the first aspect, the audio/signal and or text is analysed for emotion by the same or similar means as for the first human individual.

In one embodiment of the first aspect, the computer-implemented method comprises analysing the emotion of the first and second human individuals to determine whether the first human individual is positively, negatively, or neutrally affecting the emotion of the second human individual.

In one embodiment of the first aspect, the electronic user interface provides feedback in substantially real time.

In one embodiment of the first aspect, the electronic user interface is displayed on the screen of a smart phone, a tablet, or a computer monitor.

In one embodiment of the first aspect, the electronic user interface is configured to provide feedback in the form of emotion information for the first human individual, emotion frequency information for the first human individual.

In one embodiment of the first aspect, the electronic user interface is configured to accept emotion information from the first human individual for use as an expected output in a machine learning method.

In one embodiment of the first aspect, the electronic user interface provides output information on emotion of the second human individual.

In one embodiment of the first aspect, the electronic user interface provides suggestions for improving verbal communication or state of mind of the first human individual by a training module

In one embodiment of the first aspect, the training module analyses the output of an emotion analysis module based on the first human individual, and/or the output of a pause and/or delivery module of the first module, and/or the output of an emotion analysis module based on the second human individual.

In one embodiment of the first aspect, the computer-implemented method comprises the first human individual participating in voice communication and/or text communication via the internet or a cell phone network with one or more other human individuals.

In one embodiment of the first aspect, the user interface comprises means for allowing the first human individual to instigate, join or otherwise participate in voice communication and/or text communication via the internet or a cell phone network with one or more other human individuals

In a second aspect, the present invention provides a non-transitory computer readable medium having program instructions configured to execute the computer-implemented method of any embodiment of the first aspect.

In a third aspect, the present invention provides a processor-enabled device configured to execute the computer-implemented method of any embodiment of the first aspect.

In one embodiment of the third aspect, the processor-enabled device comprises the non-transitory computer readable medium of the second aspect.

### BRIEF DESCRIPTION OF THE FIGURES

FIG. 1 is a block diagram showing the flow of signals and information between various modules in a preferred embodiment of the invention integrating emotion detection from voice and text communications

FIG. 2 is a flowchart detailing the steps involved in assessing the fidelity of emotions identified in a preferred embodiment of the invention.

FIG. 3 is a diagram showing the centrality of real time emotion analysis from communication data obtained from an individual, and the output of emotion analysis to provide a blueprint for an individual which ranks the individual according to a predetermined level (“unreflective” through to “master”).

FIG. 4 is a block diagram showing the various functional modules in a preferred smart phone app of the present invention, along with external components which may interact with the app by way of an API.

FIG. 5 shows diagrammatically two screens of a preferred smart phone app of the invention, the left panel showing a settings icon and the right panel showing the settings screen

FIG. 6. is a block diagram showing the processing of speech-related information according to various rules, the output of which forms the blueprint of an individual.

FIG. 7 is a block diagram showing the flow of information between various elements of a system configured to analyse voice and text of an individual to provide output in the form of notifications, reports, blueprints or to an API for third party use.

FIG. 8 is a smartphone user interface that allows for input of a spoken word, analysis of the spoken word for pronunciation accuracy, and numerical output of the determined accuracy.

FIG. 9 is a smartphone user interface showing the output of the analysis of communication of an individual. The interface further shows the progress of the individual toward improved communication.

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments, or indeed any embodiment covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

The present invention is predicated at least in part on the finding that audio signals comprising human speech can be analysed in real time for emotion in the context of a voice call, videoconference, webinar or other electronic verbal communication means. The real time analysis may be performed on a relatively low powered processor, such as those found in a smart phone or a tablet. Particularly, a discontinuous audio signal may be analysed so as to limit processor burden, whilst allowing for accurate identification of an emotion. Moreover, text generated by the individual under analysis may be mined to improve the accuracy of emotion identification.

By way of non-limiting overview, the present invention involves an assessment of an individual's emotion as expressed through speech or text written the individual. An aim of such assessment may be to provide an emotion profile for the individual at first instance which functions as a baseline analysis of the individual's verbal or written communication generated before any improvement training has been undertaken. The profile may be generated having regard to the type of emotions expressed in the course of a conversation (verbal or written) or a presentation, and the length or frequency of the expression. Aspects of verbal communication requiring improvement are identified and displayed to the individual, and a customized training program generated. More broadly, aspects of an individual's general state of mind may be revealed by analysis of verbal or written communication. The emotion profile is regenerated and updated over time pursuant to such training so that the individual can assess progress.

A problem arises in so far as how to identify emotion in an individual's ordinary speech with a useful level of fidelity. In formal vocal training, a teacher will typically listen to an individual's speech in an artificially control environment. It is proposed that analysis in such circumstances fails to provide an accurate determination of how an individual will use emotion in day-to-day verbal communication. In any event, such analysis is not provided in the context of real world communication and the individual lacks real-time feedback on verbal communication. Accordingly, the present invention provides for substantially real-time analysis of an individual's speech in a real world context such as in electronic voice calls, video conferencing and webinars. Analysis of speech in such contexts is more likely to provide a useful representation of the individual's verbal communication skills, and therefore a platform from which to build communication training programs and assess progress toward better communication.

With regard to the assessment of the individual's general state of mind, an individual may become self-conscious in the course of assessment and may attempt to give the “right” answer to any questions. For example, an individual may attempt to mask an overly pessimistic outlook on life by deliberately giving misleading answers in an assessment procedure. Applicant proposes that analysis of verbal or written communications obtained in the course of everyday activities such as participating in phone conversations and text-based interactions on messaging platforms with business and personal contacts can give a greater insight into an individual's state of mind.

Advantageously, processor-based devices such as smart phones, tablets, laptop computers and desktop computers are capable of firstly capturing speech via an inbuilt or connected microphone, secondly actually analyse the audio signal from the microphone by software encoded algorithms to identify emotion, thirdly provide a visual interface to output information to the individual, and fourthly to allow for machine-based learning so as to over time improve the fidelity of emotion identification for the individual concerned. All such devices are included with the meaning of the term “computer” as used herein. Other processor-based devices presently known, or that may become known in the future are also considered to be a “computer” in the present context.

In the context of the present invention, machine learning may be implemented in respect of any one or more of voice transcription, analysis of voice for emotion, analysis of text for emotion, and speaker (i.e. individual) identification. The machine learning may receive input and transmit output to a software-implemented rule including any one of more of an NLP-based rule, an empathy rule, a word rule, an emotion rule, a point system rule, and a pronunciation rule. In turn, the various rules receive input from an transmit output to a notification, a report, a native or third party API, and a blueprint. Reference is made to FIG. 7 for further exemplary details.

Processor-based devices such as the aforementioned are further central to text-based communications such as by way of email, SMS text message, messaging platforms, social media platforms, and the like. In that regard, further advantage is provided where an individual's text- based communications are used to build the individual's emotion profile. To explain further, an individual may express emotion in text-based communications as well as verbal communications, and therefore provide a second input (the first being speech input) in identifying an emotion of an individual. The text may be generated while the individual is verbally communicating, or may be mined from historical text-based communications saved on a processor-based device real time. Where an algorithmic identification of emotion is not possible based on the analysis of speech input alone, or is not possible to a predetermined confidence level, then a second input from a text- based communication may be used to provide such determination at a certain confidence level.

It will be appreciated that the individual's written communications may be analysed alone, and identification of an emotion determined by reference only to the written communications. In one embodiment, the analysis is performed on both written and verbal communication.

Speech may be analysed for reasons other than identifying emotion in an individual. For example, speech may be converted to text, and an analysis of the transcribed speech performed. Such analysis may be directed identifying deficiencies in relation to grammar, word selection, syntax, intelligibility or sentence length. Such analysis output may be indicative of emotion (for example long sentence length or the use of expletives may indicate anger) however more typically the output will not be used as an input for emotion identification. Instead, such output may be used to separately identify other areas for improvement such as word selection (too complex versus too simple) or the use of filler words (such as “um” and “ah”). As another example speech may be analysed for clarity, pronunciation, fluency and the like, and in such cases the speech to text conversion may fail that in itself being indicative that the individual must improve actual phonics of speech. Alternatively problems with clarity, pronunciation, fluency and the like may be obtained by an analysis of the audio signal per se and without any conversion to text.

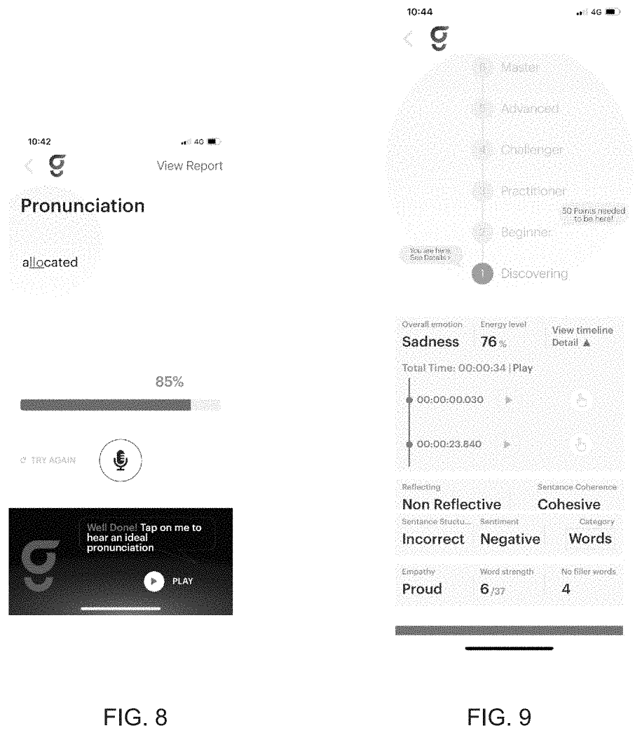

In some embodiments of the invention, speech is analysed for word pronunciation so as to alert the individual to any deficiency and to monitor for improvement with training over time. A training tool may be provided whereby the user is prompted to input a certain word via microphone (i.e. spoken) and a pronunciation analysis module compares the spoken word to one or more reference pronunciations so as to provide an accuracy to the individual. An exemplary user interface for a pronunciation tool is shown at FIG. 8.

When an individual first commences speech analysis according to the present invention, analysis for emotion will be performed according to basic algorithms that are not trained specifically for that individual's speech. Although, in some embodiments the algorithms have some form of basic parameter adjustment so as to suit a particular type of individual (e.g. male versus female, child versus adult, native speaker versus foreign speaker, or American accent versus British accent).

Over multiple uses of the method, the method exploits machine-based learning means implemented in software to fine tune the algorithms so as identify an emotion in the individual with greater fidelity. As will be appreciated, the machine-based learning means requires an expected output and in the context of the present method that may be provided by the individual.

For example a user interface may ask the individual to select a current emotion in the course of a verbal communication). As a further example, a text-based communication of the individual may be analysed to determine the individual's likely present emotion. Where the method is implemented in the context of a video signal, the individual's face may be analysed for an emotion (such as a furrowed brow being indicative of anger) with that output being used to provide an expected output for a speech-based emotion identification algorithm.

Various predetermined speech characteristics may be used by an analysis module to identify an emotion. For example, nervousness may be identified by any one or more of the following characteristics: the below attributes: prolonged lower voice pitch (optionally determined by reference to the individual's usual pitch, and further optionally determined by reference to a mean or maximum voice pitch), high-frequency components in the sound energy spectrum, the proportion of silent pauses (optionally determined by reference to the individual's usual use of silent pauses) comparative analysis of customer's use of silent pauses, spontaneous laughter, and a measure of disfluency (for example false starts and stops of words or sentences)

In another embodiment, the expected output for a machine-based learning means may be derived from a pre-recorded verbal communication with the individual inputting a recalled emotion at various stages in the recording.

Various predetermined text characteristics may be used by an analysis module to identify an emotion. For example, nervousness may be identified by any one or more of the following characteristics: a reduction in the intensity of interaction (whether by email, text message, chat reply, optionally measured by time delay in reply compared to the individual's usual delay), use of words such as “anxious”, “afraid”, “scared” and similar.

In one embodiment, the machine-based learning means exploits a neural network, more preferably a convolutional neural network, and still more preferably a deep convolutional neural network.

Convolutional neural networks are feedforward networks in so far as information flow is strictly unidirectional from inputs to output. As for artificial neural networks, convolutional neural networks are modelled on biological networks such as the visual cortex of the brain. A convolutional neural network architecture generally consists of a convolutional layer and a pooling (subsampling) layer, which are grouped into modules. Either one or more fully connected layers, as in a standard feedforward neural network, follow these modules. Modules are typically stacked to form a deep convolutional neural network. These networks consist of multiple computational layers, with an input being processed through these layers sequentially. Each layer involves different computational operations such as convolutions, pooling, etc., which, through training, learn to extract features relevant to the identification of an emotion or other feature of verbal expression, with the outcome at each layer being a vector containing a numeric representation of the characteristics. Multiple layers of feature extraction allow for increasingly complex and abstract features to be inferred. The final fully connected layer outputs the class label.

Initially (i.e. before any training by an individual user) public voice emotion databases may be used to train the emotion identification algorithm. Any one or more of the following data sources may be used for training: YouTube (the well-known video sharing platform); AudioSet (an ontology of 632 audio event classes and a collection of 2,084,320 human-labeled 10-second sound clips drawn from YouTube videos); Common Voice (by Mozilla, being an open-source multi-language speech built to facilitate training of speech-enabled technologies; LibriSpeech (a segmented and aligned corpus of approximately 1000 hours of 16 kHz read English speech, derived from read audiobooks); Spoken Digit Dataset (created to solve the task of identifying spoken digits in audio samples); Flickr Audio Caption Corpus (includes 40,000 spoken captions of 8,000 natural images, being collected to investigate multimodal learning schemes for unsupervised speech pattern discovery); Spoken Wikipedia Corpora (a corpus of aligned spoken Wikipedia articles from the English, German, and Dutch Wikipedia comprising hundreds of hours of aligned audio, and annotations); VoxCeleb (an audio-visual dataset consisting of short clips of human speech, extracted from interview videos uploaded to YouTube); VoxForge (open speech data available in 17 languages, including English, Chinese, Russian, and French); Freesound (a platform for the collaborative creation of audio collections labeled by humans and based on Freesound content); TED-LIUM corpus (consisting of approximately 118 hours of speech from various English-language Ted Talks).

The various categories of emotion as they relate to speech may be provided by the Ryerson Audio-Visual Database of Emotional Speech and Song (RAVDESS), for example.

With regard to feature extraction is concerned, any one of more of the following parameters may be used: pitch, loudness and energy. At a greater level of detail, the main stages of emotion detection may include feature extraction, feature selection and classifier. The audio signal may be preprocessed by filters to remove noise from speech samples is removed using filters. In next step, the Mel Frequency Cepstral Coefficients (MFCC), Discrete Wavelet Transform (DWT), pitch, energy and Zero crossing rate (ZCR) algorithms may be used for extracting the features. In feature selection stage a Global feature algorithm may be used to remove redundant information from features and to identify the emotions from extracted features machine learning classification algorithms. These feature extraction algorithms which are validated for universal emotions comprising such as anger, happiness, sadness and neutral.

In terms of speech-to-text processing, the use of deep learning systems has drastically improved the recognition rate of prior art systems. These systems can be trained in end-to-end manner and are very usable given the relatively simple model-building process and abilities to directly map speech into the text without the need for any predetermined alignments. Types of end-to-end architectures include attention-based methods, connectionist temporal classification, and convolutional neural network-based direct raw speech model. In the latter case, a raw speech signal is processed by a first convolutional layer to learn the feature representation. The output of first convolutional layer, (being an intermediate representation) is more discriminative and processed by further convolutional layers.

Once an emotion is identified, the present method may comprise the step of analysing the frequency or duration of the emotion over the temporal course of a verbal communication. For example, the emotion of excitement may be identified frequently in the first half of a long conference call, with the frequency reducing significantly in the second half. That finding would indicate that the individual should make a special effort to express excitement (at least vocally) even when the natural tendency is for that emotion to reduce over time. As a further example, where the frequency of vocally expressed excitement is found to be uniformly high for entire duration of a conference call then the individual should consider reserving vocal expression of excitement for circumstances only when truly warranted.

As the individual makes adjustments to his/her speech over time under the improvement program generated by the present method, the individual's profile is adjusted accordingly. Thus, where the individual's profile might initially record a level of overt aggressiveness (for example while responding verbally to a colleague's ongoing criticisms), after that problem is highlighted to the individual and adjustments made to vocal tone then the profile would no longer record overt aggressiveness as an aspect of verbal communication in need of improvement.

In some embodiments of the method, some analysis may be made of a second individual conversing with or listening to the first individual. In that regard, some emotion may be identified in the second individual (although possibly not as accurately as for the first individual), with that output being used to analyse the first individual's verbal communication. The second individual may vocally express a degree of joy suddenly, with the first individual's voice not altering in any way to reflect a commensurate change of emotion as would be expected in good verbal communication. The first individual would be made aware of that issue, and the profile updated accordingly to reflect his/her apparent disinterest in the joy another person.

As will be appreciated, a user interface may be used in the method to effect the various inputs and outputs as required. Advantageously, the user interface may be displayed on a screen (such as a touch screen or a screen being part of a graphical user interface system) on the processor-enabled device which captures the audio signal and performs analysis of the captured speech. In the method, the individual makes various inputs via the user interface, and is also provided with human-comprehensible output relating to identified emotions (including frequency information), aspects of speech clarity and fluency, grammar and the selection of words. Such information may be of use in its own to the individual who may make a successful effort to address any deficiencies displayed on the interface. Alternatively the method may output a training program by way of the user interface and/or by way of audio signal

The training program may take the form of simple written instructions, pre-recorded video instructions, live video instructions by an instructor having access to output information, video cues, or audio instructions or cues, or haptic cues.

In some embodiments, the training program is conveyed to the individual immediately or shortly after an analysed verbal communication. In other embodiments the training program is generated from two or more verbal communication sessions and displayed to the individual.

The training program may be conveyed by way of text and/or graphics and/or audio signals and or haptic means in the course of a real world verbal communication. Thus, the individual is provided with feedback on-the-fly and is therefore able to modify his/her communication in accordance with instructions or cues provided by the method as the communication progresses.

Where the communication includes a video stream the feedback may be provided by visual information or cues overlaid on or adjacent to the video conference screen. In one embodiment, emotion and frequency information is displayed allowing the user to self-correct any over or under use of an emotion. In other embodiments, actual instruction is provided, such as an advisory message of the type “speak more clearly”, “vocalise more interest”, “use shorter sentences”, “stop saying yeah, use yes instead”, and the like.

In a voice call scenario (i.e. with an audio stream only) feedback may nevertheless be displayed on an available video display screen, such as the screen of a smart phone. In the case of a smart phone screen the individual will use the speaker/microphone in “hands free” mode such that the conversation can continue while the screen may still be viewed by the individual.

In some embodiments, the feedback is provided by haptic means, such as the vibration of a smart phone. Thus, a training program may aim to correct the propensity of an individual to use very long sentences, and in which case where a long sentence is identified the smartphone vibrates in the individual's hand alerting him/her of the need to shorten sentences.

The feedback will typically be provided such that it is visible or audible only to the individual under analysis.

Any message and/or training program may be generated by the method according to a predetermined set of problems and solutions and in that regard a lookup table embodied in software may be implemented. A first column of the lookup table lists a plurality of problems in verbal communication identifiable by the method. Exemplary problems include too high frequency of negative words, too low frequency of a positive emotion, and the inappropriate aggressive response to annoyance detected in a second individual. In that regard, a second column of the lookup table may comprise the messages “use more positive words like that's great”, “be more joyous”, and “keep your temper in check!”, respectively. The next column may include training exercises such as reviewing a list of positive words, vocal exercises to express joy when speaking, and a link to a video tutorial on how to placate an annoyed customer by using soothing vocal tones and neutral language. Thus, where a particular problem is detected by way of the analysis of the method, reference to the lookup table by software instantly provides an appropriate message and training program for the individual.

In some embodiments of the method, the emotions identified in speech (and optionally the frequency or duration of expression) and/or other features of speech (such as word choice, intelligibility, fluency, and clarity) may be used to indicate an individual's general state of mind and therefore be a useful base from which improvement in state of mind can be obtained and progress measured. Typically, any training program to improve a state of mind deemed unsatisfactory (for example by reoccurrence of negative emotions as detected in verbal communications) may rely on a lookup table arrangement as described supra, although the training will be addressed not toward improved use of language, but instead improving the state of mind. Such improvement may be implemented by way of modification to cognition and/or behaviour, and may be provided by cognitive behaviour therapy as training. Information on the individual's state of mind may be recorded in his/her profile, and progress of any training program to improve state of mind monitored by reference to previously stored profile records.

Any training program to improve state of mind will typically be selected by according to a determined deficiency. For example, verbal analysis may indicate that an individual is in a generally despondent state and goal oriented video session may be pushed to the individual to complete. The training may outline various practices for the individual to adopt in order to address his/her despondency.

Cognitive behavioural therapy may be also utilised in a training program for improvement in verbal communication, assisting an individual to relate better to business and personal contacts.

A user interface may be provided allowing the individual to review various aspects of their communication, and also an overall ranking of their communication skills. Over time, and with training, the various aspects and overall ranking would be expected to rise, thereby motivating the individual toward further improvement still. Reference is made to the exemplary user interface of FIG. 9.

In one embodiment, the user interface comprises means to instigate or participate in a verbal communication. For example, the interface may allow a data connection to be made with a cell phone dialling software application, a Wi-Fi call software application, a chat application, a messaging application, a video conferencing application, a social media application, or a work collaboration application. The interface may further allow a user to accept or participate in a communication. The data connection may allow software of the method to access audio signals from a microphone so as to allow analysis of speech, or to access text-based communications of the individual so as to allow for analysis thereof.

The foregoing description of the invention is made by reference to methods. In describing the methods, reference is made to various hardware, systems, software, algorithms, user interfaces, and the like. It will be understood that any particular disclosure with regard to the methods may be applied to a non-method aspect of the invention such as hardware, systems, software, algorithms, user interfaces, and the like.

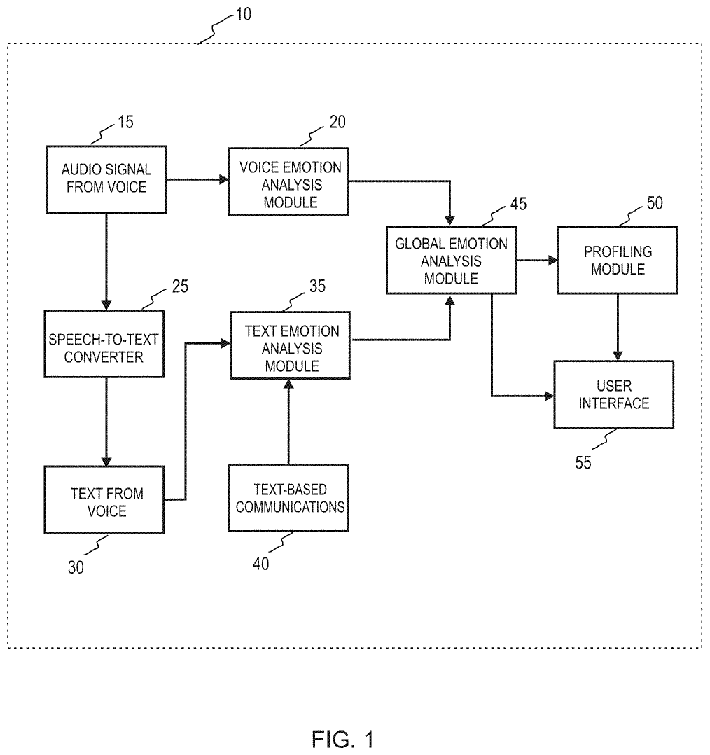

Turning firstly to FIG. 1, there is shown a block diagram of an exemplary form of the invention at an abstracted level. Given the benefit of the present specification the skilled person is enabled to implement a practical embodiment from the abstraction drawing in FIG. 1.

All components, signals, information and processes are within a communications device (10). Typically, the device (10) is a mobile device such as a smart phone or tablet capable of sending and receiving voice and text communications to and from another individual or a group of individuals.

An audio signal (15) is obtained from a microphone that is integral with or in operable connection with the device (10). The signal (15) carries the speech of an individual subject to analysis, the individual typically being a person seeking to improve the verbal communication and/or their general state of mind.

The audio signal (15) is analysed by a voice emotion analysis module (20) being implemented in the form of software instructions held in memory of the device (10) with the software instructions executed by a processor of the device (10). The function of the voice analysis module (20) is to receive the audio signal (15) as an input, identify an emotion in the voice of the individual by algorithmic or other means, and output information any identified emotion.

The audio signal (15) is also sent to a speech-to-text converter (25) being implemented in the form of software instructions held in memory of the device (10) with the software instructions executed by a processor of the device (10). The function of the converter (20) is to receive the audio signal (15) as input, identify language (words, numbers, sentences etc.) in the speech carried by the signal (15) by algorithmic or other means, and output any identified language as text (30).

The text output by the speech-to-text converter (25) is analysed by a text emotion analysis module (35) being implemented in the form of software instructions held in memory of the device (10) with the software instructions executed by a processor of the device (10). The function of the text emotion analysis module (35) is to receive the text from voice (30) as an input, identify an emotion in the text by algorithmic or other means, and output information on any identified emotion.

The device (10) is capable of sending text-based communications (40) of the individual using the device (10) in the form of, for example, an email, SMS text message, internet messaging platform and social media posts. The text-based communications are (40) input into and analysed by the text emotion analysis module (35) which functions to identify an emotion in the text by algorithmic or other means, and output information on any identified emotion.

Both the voice emotion analysis module (20) and the text emotion analysis module (35) output information on an identified emotion to the global emotion analysis module (45). The function of the global emotion analysis module (45) is to receive information on an emotion from one or both of the voice emotion analysis module (20) and the text emotion analysis module (35) as input(s), and determine a global emotion by algorithmic or other means, and outputs information on a global emotion. Where the inputs are the same or similar emotion, the emotion determined by the global emotion analysis module (45) will be expected to be of high fidelity given the concordance of emotion expressed by the individual in verbal communication and written communication. Conversely, where there is a significant lack of concordance between the emotions output by the voice emotion analysis module (20) and the text emotion analysis module (35) the global emotion analysis module (45) may not output a global emotion given the possibility that the global emotion information is of low fidelity. In any event, information on emotion output from the global analysis module may be displayed on the user interface (55) in real-time for monitoring by the individual thus allowing the individual to self-correct any undesirable emotion being expressed in the course of a conversation (voice or text-based).

As will be appreciated, the global emotion analysis module may output a global emotion multiple times in the course of a verbal communication, or multiple times over the course of an hour, day, week or month so as to provide sufficient information for building a profile of the individual. Such a profile is generated by the profiling module (50), which functions to receive information on an emotion from the global emotion analysis module (45) and generates a profile of the individual by algorithmic or other means, and outputs the profile to the user interface (55) for monitoring by the individual. The profile will typically be representative of the emotional state of the individual over a certain time period (such as a day, a week, or a month). Multiple profiles may be generated over time allowing for a comparison to be made between profiles and identification of any trends or alteration in emotional state of the individual.

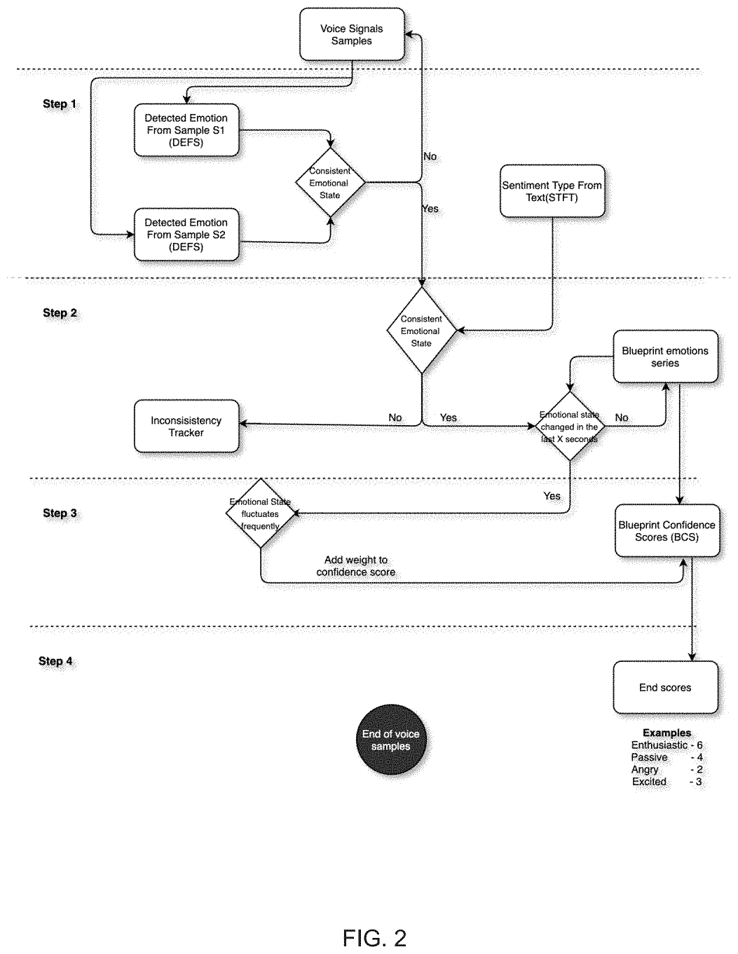

The various outputs of the various emotional analysis modules can be weighted (high or low confidence) or even discarded according to any consistency of lack of consistency in emotion information output by each. For example, a number speech samples taken over a time period may be each assessed for emotion, and where a lack of consistency is noted the emotion information is discarded and further samples taken until some consistency is noted (reference is made to step 1 of FIG. 2).

Where a consistent emotional state is found by speech analysis, a cross-check is performed by way of text analysis and if the emotion identified via text analysis is consistent with that identified from the speech analysis then the individual's emotion profile (“blueprint”) may be updated. If the cross-check fails, then all output information is discarded and analysis of fresh voice samples is recommenced (reference is made to step 2 of FIG. 2).

Reference is made to FIG. 5 showing exemplary means by which a blueprint for an individual may be generated by way of analysis of speech characteristics input according to various rules embodied in software. Each speech characteristic has a dedicated rule, with output from ach rule being used to form the blueprint.

Multiple emotional profiles are generated over time, and if an impermissible minimal level of fluctuation in emotional state is detected over a given time period, then a low confidence rating may be attached to the profile. Where a confidence rating is sufficiently low, one or a series of profiles may be discarded. Where low fluctuation in emotional state is evident, a profile may be associated with a high confidence score thereby giving the individual greater certainty that the profile is a true reflection of emotional state (reference is made to steps 3 and 4 of FIG. 2).

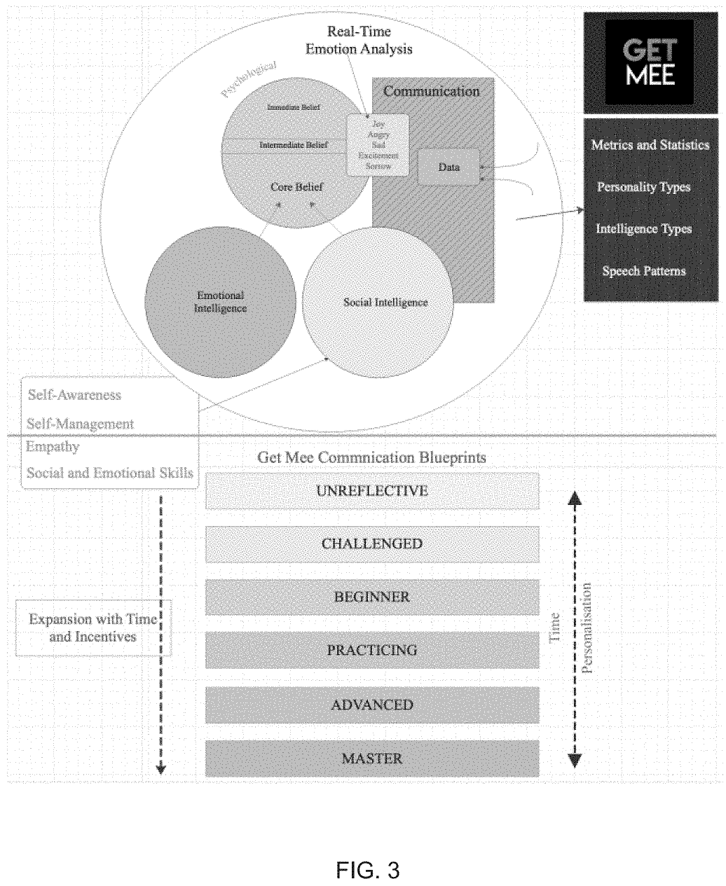

Reference is now made to FIG. 3 while shows in the upper portion the input of data generated by the present systems to, and in real time from audio input, output one or more detected emotions (such as joy, anger, sadness, excitement, sorrow) and to combine that output with parameters such as immediate belief, intermediate belief, and core belief; emotional intelligence and social intelligence (the latter including inputs relating to self-awareness, self-management, empathy, and social and emotional skills) to provide a real-time emotion analysis. Outputs of the analysis may be further processed mathematically to provide metrics and statistics, or algorithmically to determine a personality type, intelligence type or speech pattern. Thus, output of the present systems may be used in the context of broader profiling of an individual beyond verbal communication. Any issue identified in the broader filing may be subject to a training or coaching program (as for verbal communication) with the aim of overall aim of general self-improvement.

The lower portion of FIG. 3 shows exemplary communication blueprint types ranging from “unreflective” (generally undesirable, and requiring communication improvement) through to “master” (generally desirable, and having no or few communication deficits). An individual strives via a training program to progress uni-directionally toward “master”, although it is anticipated that some lapses may result in retrograde movement toward “unreflective”. Over time, however, it is contemplated that a net movement toward “master” will result, optionally with the use of training tools such as providing incentives or rewards for positive communication attributes.

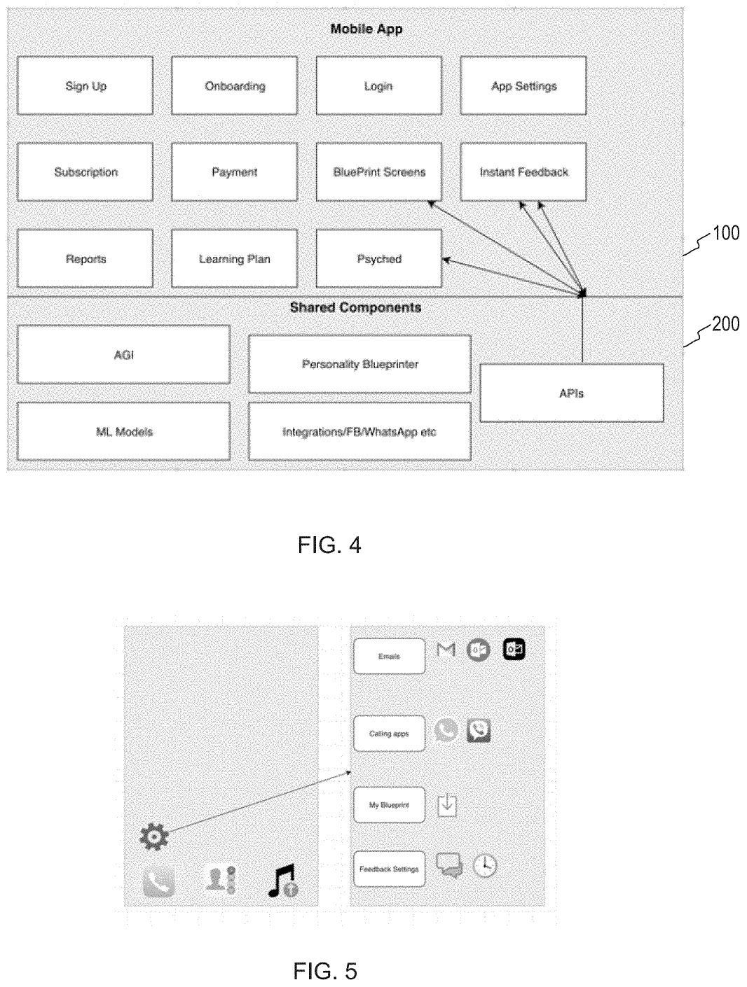

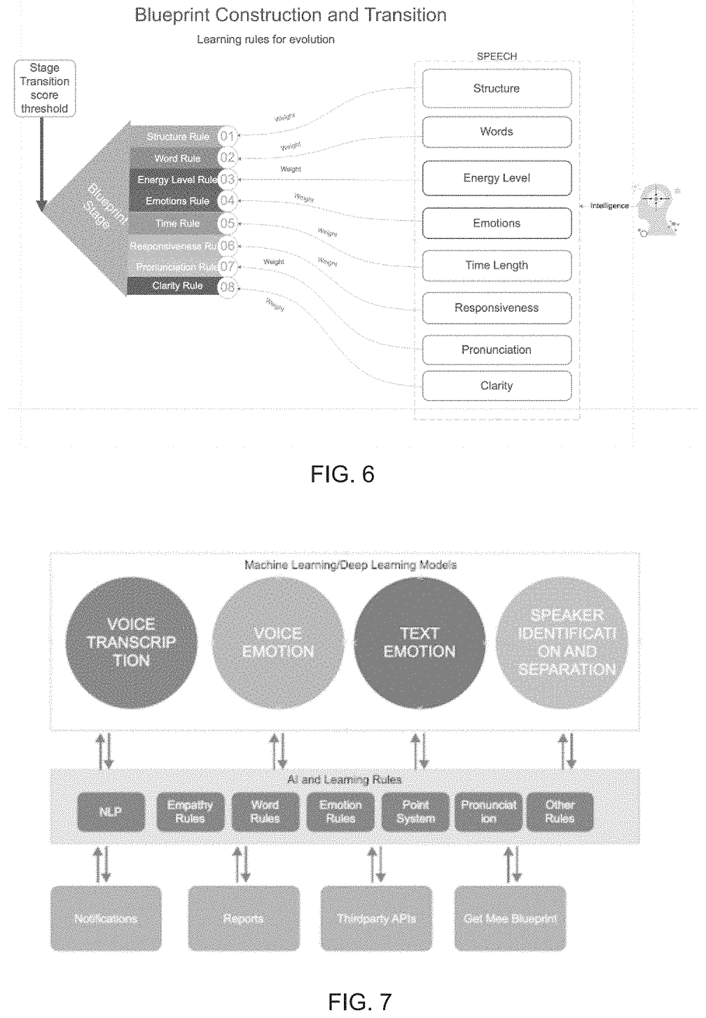

The present invention may be embodied in the form software, such as a downloadable “app”. Reference is made to FIG. 4 showing functional modules of a smart phone app (100), showing art-accepted modules (sign up, onboarding, login, settings, subscription, and payment) as well as modules particular to the present invention (blueprint screens, instant feedback, reports, learning plan and psyched).

FIG. 4 also shows external shared components (200), which are capable of interfacing with the app via one or more APIs (application programming interfaces). For example, machine learning models may operate from a separate software element that may even be executed on remote processor. Similarly, integration with separate text-based communication apps or a phone app may be provided by way of an API.

Reference is now made to FIG. 5 which shows the app has a settings icon (left panel) which when activated (right panel) reveals integration features allowing the app to access emails as a source of text-based communication and calling apps as inputs for emotion identification. The settings screen also allows for customization of an emotion profile (“blueprint”) and feedback.

As will be apparent from this detailed description, various embodiments of the invention are reliant on a computer processor and an appropriate set of processor-executable instructions. The role of the computer processor and instructions may be central to the operation of the invention in so far as digital and/or analogue audio signals or text are received. Accordingly, the invention described herein may be deployed in part or in whole through one or more processors that execute computer software, program codes, and/or instructions on a processor. Most typically, the processor will be self-contained and physically a part of a communication device. However, it is possible that the processor may be part of a server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a coprocessor (math co-processor, graphic co-processor, communication co-processor and the like) and the like that may directly or indirectly facilitate execution of program code or program instructions stored thereon. In addition, the processor may enable execution of multiple programs, threads, and codes.

The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere.

Any processor or a mobile communication device or server may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the processor may be a dual core processor, quad core processors, other chip-level multiprocessor and the like that combine two or more independent cores (called a die).

The methods and systems described herein may be deployed in part or in whole through one or more hardware components that execute software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, computers, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, computers, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, calculations, algorithms, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, EVDO, mesh, or other networks types.

The methods, programs codes, calculations, algorithms and instructions described herein may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon.

Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on computer readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on computers through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

Furthermore, the elements depicted in any flow chart or block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a computer readable medium.

The Application software may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The invention may be embodied in program instruction set executable on one or more computers. Such instructions sets may include any one or more of the following instruction types:
Data handling and memory operations, which may include an instruction to set a register to a fixed constant value, or copy data from a memory location to a register, or vice-versa (a machine instruction is often called move, however the term is misleading), to store the contents of a register, result of a computation, or to retrieve stored data to perform a computation on it later, or to read and write data from hardware devices.
Arithmetic and logic operations, which may include an instruction to add, subtract, multiply, or divide the values of two registers, placing the result in a register, possibly setting one or more condition codes in a status register, to perform bitwise operations, e.g., taking the conjunction and disjunction of corresponding bits in a pair of registers, taking the negation of each bit in a register, or to compare two values in registers (for example, to see if one is less, or if they are equal).
Control flow operations, which may include an instruction to branch to another location in the program and execute instructions there, conditionally branch to another location if a certain condition holds, indirectly branch to another location, or call another block of code, while saving the location of the next instruction as a point to return to.
Coprocessor instructions, which may include an instruction to load/store data to and from a coprocessor, or exchanging with CPU registers, or perform coprocessor operations.

A processor of a computer of the present system may include “complex” instructions in their instruction set. A single “complex” instruction does something that may take many instructions on other computers. Such instructions are typified by instructions that take multiple steps, control multiple functional units, or otherwise appear on a larger scale than the bulk of simple instructions implemented by the given processor. Some examples of “complex” instructions include: saving many registers on the stack at once, moving large blocks of memory, complicated integer and floating-point arithmetic (sine, cosine, square root, etc.), SIMD instructions, a single instruction performing an operation on many values in parallel, performing an atomic test-and-set instruction or other read-modify-write atomic instruction, and instructions that perform ALU operations with an operand from memory rather than a register.

An instruction may be defined according to its parts. According to more traditional architectures, an instruction includes an opcode that specifies the operation to perform, such as add contents of memory to register—and zero or more operand specifiers, which may specify registers, memory locations, or literal data. The operand specifiers may have addressing modes determining their meaning or may be in fixed fields. In very long instruction word (VLIW) architectures, which include many microcode architectures, multiple simultaneous opcodes and operands are specified in a single instruction.

Some types of instruction sets do not have an opcode field (such as Transport Triggered Architectures (TTA) or the Forth virtual machine), only operand(s). Other unusual “0-operand” instruction sets lack any operand specifier fields, such as some stack machines including NOSC. Conditional instructions often have a predicate field—several bits that encode the specific condition to cause the operation to be performed rather than not performed. For example, a conditional branch instruction will be executed, and the branch taken, if the condition is true, so that execution proceeds to a different part of the program, and not executed, and the branch not taken, if the condition is false, so that execution continues sequentially. Some instruction sets also have conditional moves, so that the move will be executed, and the data stored in the target location, if the condition is true, and not executed, and the target location not modified, if the condition is false. Similarly, IBM z/Architecture has a conditional store. A few instruction sets include a predicate field in every instruction; this is called branch predication.

The instructions constituting a program are rarely specified using their internal, numeric form (machine code); they may be specified using an assembly language or, more typically, may be generated from programming languages by compilers.

Those skilled in the art will appreciate that the invention described herein is susceptible to further variations and modifications other than those specifically described. It is understood that the invention comprises all such variations and modifications which fall within the spirit and scope of the present invention.

While the invention has been disclosed in connection with the preferred embodiments shown and described in detail, various modifications and improvements thereon will become readily apparent to those skilled in the art.

Accordingly, the spirit and scope of the present invention is not to be limited by the foregoing examples, but is to be understood in the broadest sense allowable by law.

1. A computer-implemented method for providing automated feedback on verbal or textual communication, the method comprising:
(i) in respect of verbal communication analysing an input audio signal comprising speech of a first human individual by one or more audio signal analysis modules so as to identify a presence, absence or quality of a speech characteristic and/or a syntax characteristic, and
outputting feedback on the presence, absence or quality of a speech characteristic or a syntax characteristic by an electronic user interface so as to be comprehensible to the first human individual; or
(ii) in respect of textual communication, analysing an input text written a first human individual by one or more text analysis modules so as to identify a presence, absence or quality of a text characteristic and/or a syntax characteristic, and
outputting feedback on the presence, absence or quality of a text characteristic or syntax characteristic by an electronic user interface so as to be comprehensible to the first human individual.

2. The computer-implemented method of claim 1, comprising obtaining the input audio signal from a microphone transducing speech of the first human individual in participating in an activity selected from the group consisting of: a cell phone voice call, an IP phone voice call, a voicemail message, an online chat, an online conference, an online videoconference, and a webinar.

3. The computer-implemented method of claim 1, comprising analyzing discontinuous portions of the input audio signal so as to lessen processor burden of the computer executing the method.

4. The computer-implemented method of claim 1, wherein the analysis of the input audio signal, or discontinuous portions of the input audio signal occurs substantially on-the-fly.

5. The computer-implemented method of claim 1, wherein the one or more audio signal or text analysis modules comprises an emotion analysis module configured to identify an emotion in speech or text.

6. (canceled)

7. The computer-implemented method of claim 1, wherein the one or more audio signal analysis modules comprises a comprehensibility or pronunciation analysis module configured to identify a comprehensibility or pronunciation speech characteristic.

8. The computer-implemented method of claim 1, wherein the one or more audio signal analysis modules comprises a volume or frequency analysis module configured to identify a volume or a frequency (pitch) speech characteristic.

9. The computer-implemented method of claim 1, wherein the one or more audio signal analysis modules comprises a delivery and/or pause analysis module configured to identify a speed of delivery and/or a pause speech characteristic.

10. The computer-implemented method of claim 1, wherein the one or more audio signal analysis modules comprises a speech-to-text converter module configured to convert speech encoded by the audio signal into a text output.

11. (canceled)

12. The computer-implemented method of claim 1, wherein the one or more text analysis modules is/are configured to input the text written by the first human individual, the text being in the form of a word or a word string.

13. (canceled)

14. (canceled)

15. The computer-implemented method of claim 1, wherein the one or more text analysis modules comprises a module configured to analyse a word or a syntax characteristic of text.

16. (canceled)

17. The computer-implemented method of claim 1, wherein the one or more text analysis modules comprises an emotion analysis module configured to identify an emotion in text.

18. (canceled)

19. The computer-implemented method of claim 5, wherein the emotion analysis modules is trained to identify an emotion in an audio signal of human speech by reference to a population dataset.

20. The computer-implemented method of claim 19, comprising training the emotion analysis module by use of a machine learning method so as to associate a characteristic of an audio signal with an emotion by reference to the population dataset

21. The computer-implemented method of claim 1, comprising ongoing training of a machine learning module by ongoing analysis of audio signals of the first human individual so as to increase accuracy over time of the emotion analysis module.

22. The computer-implemented method of claim 5, wherein the emotion analysis module identifies an emotion in text by reference to an electronically stored predetermined association between (i) a word or a word string and (ii) an emotion.

23. (canceled)

24. The computer-implemented method of claim 5, comprising receiving output from the emotion analysis module by a profiling module and generating a profile of the first human individual.

25. (canceled)

26. (canceled)

27. The computer-implemented method of claim 1, comprising analysing an input audio signal comprising speech of a second human individual by one or more audio signal analysis modules so as to identify the presence or absence of a speech characteristic and/or a syntax characteristic, wherein the second human individual is in communication with the first human individual.

28. (canceled)

29. (canceled)

30. (canceled)

31. (canceled)

32. The computer-implemented method of claim 1, wherein the electronic user interface provides feedback in substantially real time.

33. (canceled)

34. (canceled)

35. (canceled)

36. (canceled)

37. The computer-implemented method of claim 1, wherein the electronic user interface provides suggestions for improving verbal communication or state of mind of the first human individual by a training module.

38. (canceled)

39. (canceled)

40. (canceled)

41. (canceled)

42. (canceled)

43. (canceled)
